(19) United States
(12) Patent Application Publication
(10) Pub. No.: US 2024/0185301 A1
(43) Pub. Date: Jun. 6, 2024

(54) SYSTEMS AND METHODS OF DELIVERING ANONYMIZED TARGETED ADVERTISEMENTS WHILE PROVIDING MULTI-LEVEL COMPENSATION TO USERS

(71) Applicant: Glenn D. Oliver, San Diego, CA (US)

(72) Inventor: Glenn D. Oliver, San Diego, CA (US)

(21) Appl. No.: 18/074,034

(22) Filed: Dec. 2, 2022

Related U.S. Application Data
(60) Provisional application No. 63/385,729, filed on Dec. 1, 2022.

(51) Int. Cl. G06Q 30/0251; G06Q 30/0207; G06Q 30/0214

(52) U.S. Cl. CPC G06Q 30/0269; G06Q 30/0214; G06Q 30/0215

(57) ABSTRACT

Systems and methods of delivering anonymized, targeted advertisements via a computer network to self-identified users that includes multi-level compensation for user referrals.

### CROSS-REFERENCE TO RELATED APPLICATIONS

The present application claims priority to U.S. Provisional Application No. 63/385,729 filed Dec. 3, 2021, titled “SYSTEMS AND METHODS OF DELIVERING ANONYMIZED TARGETED ADVERTISEMENTS WHILE PROVIDING MULTI-LEVEL COMPENSATION TO USERS,” which is hereby incorporated by reference in its entirety.

### TECHNICAL FIELD

Embodiments of the invention relate to systems and methods for users of an advertising platform to earn income, both active and passive, by watching digital advertisements.

### BACKGROUND

The digital advertising industry has many challenges. First, one of its fundamental premises is based on tracking people in order to determine their interests. A wide range of people do not appreciate or want to have their activities tracked by anyone, including companies. They often feel that tracking their digital movements is an invasion of their privacy.

Second, Google™ and Apple™ have two of the largest digital advertising platforms in the world. Apple™ has recently started to require user owners of their smartphone iPhone™ to “opt-in” to any third-party tracking. Most users have declined or otherwise refused to opt-in. Google™ has announced that it is planning to prevent third-party tracking of users of its Google Chrome™ M browser.

As a result of issues caused by the first and second points above, advertisers are now struggling to discover new ways to find and send advertisements to their target audience without the use of their traditional tracking systems.

Users of modern Internet-connected technology devices are becoming increasingly aware that their data is being used by advertisers and has inherent value. Many of these users have even begun to explore new and existing ways of monetizing their digital usage and profile data for their own benefit. They are often interested in solutions that monetize this data without compromising their own privacy. There are no solutions that allow users to profit by selling or otherwise using their personal data and the data of those they may refer or interact with online and even offline.

Currently, there is no system or method for businesses of differing sizes to earn passive revenue from digital advertisements by referring their customers to a service where the customers may earn money or rewards by viewing or reading advertisements. Similarly, churches, organizations with memberships, neighborhood groups, and others cannot currently earn passive revenue by referring their members to similar services.

Some existing websites may allow users to be paid for clicking and viewing randomized advertisements. However, these sites do not have an affiliate referral component, do not have a coded system for delivering anonymous targeted advertisements, and do not permit business to business, consumer to consumer, and business to consumer passive income creation.

Thus, it would be beneficial and needs exist for individuals and group entities to earn multi-level passive income when their referrals view advertisements. Furthermore, referrals of other entities may earn even more passive income and multiple levels of income generation may be employed.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The example embodiments provided herein relate to and disclose platforms for viewing advertisements that provide income to viewers and their referrers and referrals.

The current embodiments permit payment of referral income down to multiple levels (e.g. three levels down). Other embodiments provide further downward payments.

In some embodiments a coding system is implemented which can be static and/or fixed. In some embodiments organic, fluid, and/or variable coding systems can allow users to self-select or be automatically placed in new categories. This can allow users to add and to be paid for viewing advertisements regarding their selected interests, hobbies, favorites, or the like.

Websites, mobile and tablet applications, and desktop portals are contemplated.

In one aspect, users can disclose or select interests or enter other profile information into the system, which can lead to new advertising code sections that they are associated with. Organic codes can also be added, updated, and customized in limitless ways.

In one aspect, nearly any person or entity can earn passive income through referrals. These can include businesses, organizations, churches, individuals, and others. These referrals can pass income through multiple levels.

In one aspect, referral systems are included. These can allow affiliates to earn passive income through payments on the multiple levels below them who have joined and selected advertisements to view.

In one aspect, systems and methods permit business to business (B2B), business to consumer (B2C), and/or consumer to consumer (C2C) referrals. The system enables all of these users to earn passive income on multiple levels.

In one aspect, coding systems and methods are provided that allow users to identify interests and add additional profile information that allows the system to target advertising while the users also remain anonymous to advertisers.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

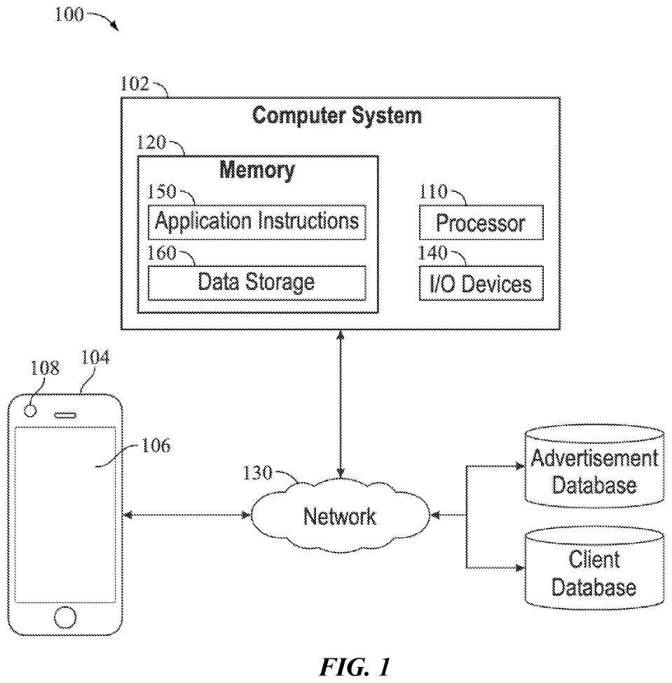

FIG. 1 illustrates a system architecture diagram, according to some embodiments;

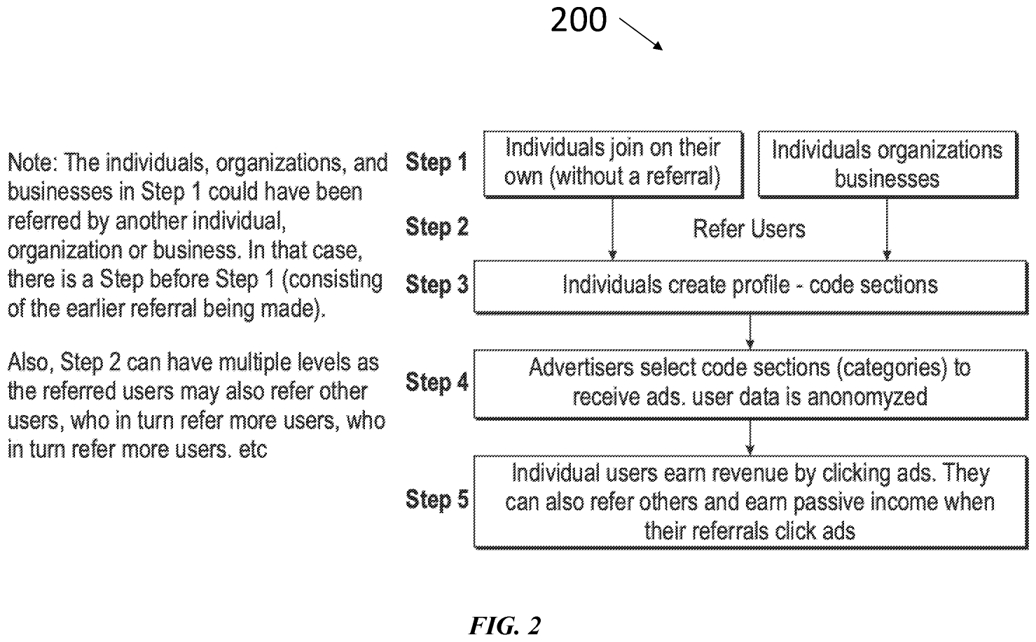

FIG. 2 illustrates a user experience flowchart, according to some embodiments;

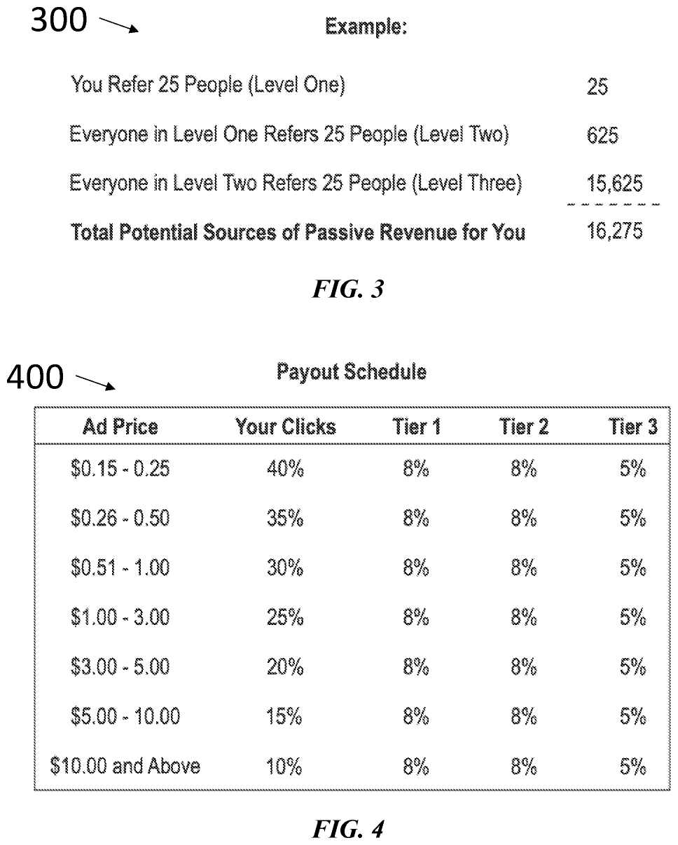

FIG. 3 illustrates an example scaling table, according to some embodiments;

FIG. 4 illustrates a payout schedule diagram, according to some embodiments; and

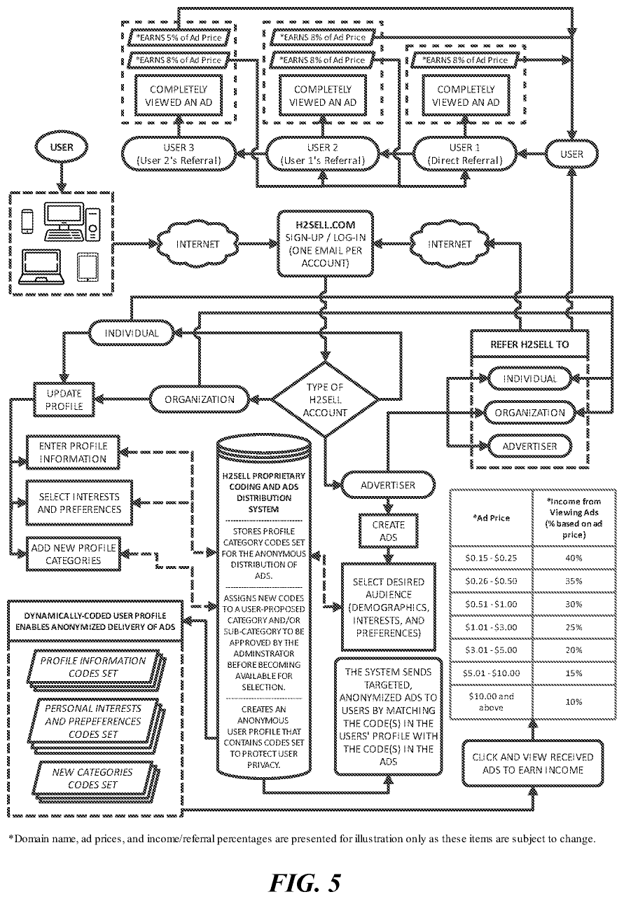

FIG. 5 illustrates a flowchart of a system and method for delivering anonymized targeted advertisements while providing multi-level compensation to users, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102, coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g. a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

Also shown in FIG. 1 are one or more advertisements database(s) and client database(s). These databases can be locally stored in memory or remotely stored in memory that is accessible by computer system 102 via network 130 and may be proprietary, public, or some combination thereof. These databases can also be third-party or system databases in some embodiments and may have one of any manner of structures, privacy measures, and other features and elements. Advertisement database(s) can include advertisements that the system 102 sends to users via the network 130. All manner of tagging and different organization schemes can be used to track and store advertisements in order to accurately serve them to users. Client database(s) can include profiles for users that save payment information, statistical data, preferences, affiliates, referrals, and other information for use by computer system 102. In some embodiments, Client database(s) can include profiles for various companies, organizations, and other advertisers who may maintain searchable and reviewable profiles by system users.

It should be understood that user data is anonymized for the purpose of delivering advertisements, but for administrative purposes user data cannot be or is not anonymized. For example, automated portinos of the system and administrative users is/are able to communicate with users, handle user issues, serve advertisements, associate referrals, and make payments to users based on user data stored with the system. However, none of this type of personalized data is accessible or usable by advertisers themselves.

A coding system for recording and categorizing users' profile features (for example, demographic data, location, interests, wants, desires, hobbies, and many others) is included in the systems and methods herein in many embodiments. The coding system can be organic, meaning it grows as more users add new category sections, as videos are tagged with particular labels, and in other ways. These codes or tags can include interests, hobbies, and others that are not included in prior or currently existing versions of a code key. As such, the system can “learn” new interests, hobbies, or other categories and in some instances it can make or serve recommended advertisements to users based on these new codes that are associated with user profiles.

In some embodiments codes can be cross-referenced with each other in order for the systems and methods to be robust. As such, one coded interest may be cross referenced with other coded interests users may be presented with recommended new codes at different points in time while using the system (e.g. at sign-in, after viewing an advertisement or a number of advertisements of one code type). For example, a user may be subscribed to a code “animals,” which may be cross-referenced with further codes “pets” and “birds.” If a user views an animals coded video, they may then be shown one that is tagged with pets or birds, and/or given the option to subscribe to such tags to be shown related videos in the future. Declining to add a recommended or associated code can also help the system learn which codes may be relevant to present to the user or similar users in the future. Codes can be product/service related and can also be related to the subject matter of the advertisements themselves in some embodiments. If a user consistently “likes” or rates advertisements with a particular tag or code highly, they may be shown more of that type of advertisement or more advertisements in that category or code. These can be mood or emotion based (e.g. sentimental, happy, thought-provoking, or others), based on the type of advertisement (e.g. action based ads, funny ads, ironic ads, or others) or can be related to categories/codes. Conversely, if they consistently “dislikes,” “downvotes,” or rates advertisements of a particular tag negatively or poorly, they may be shown fewer similarly tagged advertisements in the future.

In some embodiments, codes can also be blocked by users who wish to not view advertisements for particular types of products or for particular advertisers. For example, users may wish to block alcohol or tobacco advertisements from their own viewing (or in some cases, from their minor children's viewing) and they may therefore disable or prevent advertisements tagged with such codes. Likewise, objectionable or immoral advertisements may be blocked by a church group or other religious organization's account, for instance.

In some instances, if a business refers a new user to the platform and the user selects, views, or likes an advertisement from a competitor, then the business can earn a reward from the viewing of their competitors advertisement.

Advertisements are supplied to and via the platform and/or placed by advertisers. Advertisers can have one or more account managers with access to their advertisements who can select categories to target for their own advertisements in some embodiments. Advertisers may also have more than one account for different divisions or product lines, depending on size, need, and nature of the advertiser organization. In some embodiments system administrators who are not associated with the advertisers directly can select categories/codes for advertisements. In some embodiments the system can automatically categorize advertisements based on subject matter, goods or services sold, and/or other information about the seller, manufacturer, or otherwise. Artificial intelligence (AI) and/or machine learning (ML) may be employed in various embodiments to parse information about advertisements and categorize, tag, or code them accordingly.

AI/ML can also be implemented in many embodiments for a range of different purposes. In some embodiments it can help to present better results based on anonymized profiles of other users who may have selected similar categorical interests. In some embodiments it can be employed to present advertisements that a user is more likely to rate highly, based on the user's prior ratings of similar advertisements. In some embodiments it can be used based on a user's referrals or affiliates in order to present particular types of advertisements that may be of interest to users. Numerous other purposes and results can also be affected through the use of AI/ML.

Included herein are embodiments of a multi-level referral system where users are assigned one or more referral codes that can be used to refer other users. This allows the system to track all referrals back to their point of origin, often an original user, organization, or entity, and also enables or provide a means for users to earn passive revenue when their referrals interact with the system, such as by clicking or selecting advertisements to watch, read, listen to, or otherwise review. The system can pass revenue through multiple levels of referrals, allowing an originator to earn from their referrals, referrals of referrals, and more.

The various embodiments described herein provide the ability for groups, churches, businesses, and other organizations to earn multi-level passive revenue. An administrator or other person in an authority or designated position can be given one or more referral code(s) that they can share with their friends, members, employees, customers, clients, or other people. These referral codes are uniquely assigned and allow the group, church, business, or other organization to earn passive revenue when their referrals interact with the system, such as by clicking or selecting advertisements to watch, read, or otherwise review. The system can pass revenue through multiple levels of referrals, allowing an originator to earn from their referrals, referrals of referrals, and more.

Many embodiments provide a means for advertisers to send targeted advertisements to anonymous users who may be interested in their products or services. Users are able to select code or tag categories that will show them particular types of advertisements. The user's personal information is not shared with any of the advertisers. Feedback on the advertisements can be provided by users in some embodiments, generally anonymously. Some metrics may allow advertisers to collect and review statistics of anonymous viewers. For example, advertisers may be able to view the favorability or rating of advertisements in sorted or tagged fashion, whereby they may be able to view feedback for users who are subscribed to a particular code or tag. For a travel company with a travel advertisement, they may sort viewer feedback based on which users subscribe to the tag “Bahamas” or “ocean” or “beach” or “cruise” or other relevant coding. In many embodiments, advertisers may be the only parties who can view feedback, other than system administrators. As such, users will be prevented from influencing other users' opinions or perceptions.

Included herein are various embodiments implementing means for advertisers to deliver targeted advertisements to users without tracking, cookies, or monitoring any user activity via the Internet or other network. As such, the platform does not install or utilize any monitoring software on users' devices to recognize their locations, purchasing habits, Internet usage, or the like. The platform also does not surreptitiously utilize any audio, image, and/or video surveillance of users, as other platforms are known to currently perform. These non-tracing and non-monitoring standards apply both while users are actively engaged with and using the platform and when they not using the platform. In some embodiments the system itself can utilize one or more benign metrics that measure and apply only to a user's engagement with the system itself. As such, the system may identify whether a user has logged into the system before from a particular IP address, determine if a user has skipped a video or ended it early, if the user has liked, disliked, or rated a video, and/or if they have engaged with other features of the system itself. However, these benign means of measuring usage may be limited in the type of data they generate and the type of data that may ever be presented to advertisers. All information that is tracked may be explicitly communicated to users in various embodiments and in some embodiments users may disable or otherwise turn off particular types of data collection and measurement tools. These and other privacy measures, including the anonymous nature of user accounts, ensures that user data is not being misused, used for clandestine operations by companies, governments, and/or other organizations and entities.

As discussed in various portions of this document, the systems and methods described herein can include a variety of means for the user to control any personal information that is used to direct advertisements that are then displayed to the user. To the extent that any personal information is stored, it is minimized to the greatest extent possible, while still allowing for functionality of the systems and methods. Thus, since users are rewarded monetarily for viewing advertisements, currency exchange information may be one vital type of information that the system does store in encrypted and/or other private fashion. Users may be able to connect their system account with a bank account, digital wallet, or other means for storing value and receiving payment for their own advertisement viewing and that of their downstream referrals. In some embodiments the system may simply generate single use or multi-use codes that can be used to transfer currency (e.g. government backed money, cryptocurrency, gift certificates, rebates, rewards, or others) that can be used in conjunction with secondary or third-party transfer and/or conversion platforms before the user may claim their rightfully earned payment.

The systems and methods described can include at least one means for advertisers to refer customers and send advertisements to them. As such, advertisers are not excluded from passive revenue generation as other entities can earn. Instead, advertisers can also earn revenue if their customers sign up using their referral code(s) (advertisers can earn passive revenue on multiple levels like other users when their referrals click their advertisements). An advertiser can also earn revenue when users and even their own referrals click the advertiser's advertisements. Earned revenue can be credited to an advertiser's system account to pay for placing future advertisements through the system and/or it can be taken as cash, credit, or other rebates.

As described herein, system functions and the various related methods can be served on a website or other platform that is accessible by users, entities, and advertisers via the Internet, private network(s), or combinations thereof. Users and advertisers can generally access the website or platform whenever they desire or otherwise on-demand. In some embodiments, advertisers can create campaigns that may release advertisements at certain times and with a frequency of their own choosing. Advertisers and/or the system itself can offer incentives to users (e.g. double payouts, watch three advertisements and get paid for watching four, or numerous others, time of day viewing incentives, signing in every day incentives, or others) that encourage users to use the platform in certain ways and/or to drive engagement. Particular tags or codes can also have different incentivization structures. Advertisers may also pay to have more placements, more frequent placements, or drive other goals.

In some embodiments, users can refer advertisers and the user may then receive a portion of the money that the advertiser spends on advertisements. The user can provide the advertiser their referral link or their referral code (which allows us to know that the user made the referral). If an advertiser signs up from a referral link or enters a referral code when signing up, then the advertiser may also receive a benefit, such as a a discount on the advertisements they place with the system.

FIG. 2 illustrates a user experience flowchart 200, according to some embodiments. As shown in the example embodiment, as a first step, a user (individual and/or entity) may join on their own or may have been referred by another user or entity. As a second (optional) step (that may take place at other points in the process as well), the new joiner may refer additional users, who may sign up using referral codes or otherwise note with the system that they have been referred by an existing user. Next, the user can create a profile and add one or more codes that are related to advertisements that they are interested in viewing (e.g. demographic information, location, hiking, swimming, crochet, reading horror novels, or virtually any others). Advertisers who have selected or added such codes to their advertisements may then have their advertisement(s) displayed to the anonymous users who have selected such categories or codes to view. User data can remain anonymous and will not be stored or displayed to advertisers in a manner in which they can associate it with any particular user account. Finally, users can earn revenue by selecting and viewing advertisements. This may include selecting advertisements from a grid, list, array, or other display means that may include a title, advertiser, brand, product, or other information that is relevant to the advertisement. Users may also be able to refer their friends, family, coworkers, or other individuals to join the system by entering contact information such as an email or social media account handle or name that the system can contact automatically or manually.

FIG. 3 illustrates an example scaling table 300, according to some embodiments. As shown in the example embodiment, the system can easily scale the potential passive income that any user or entity may earn. As shown, a first user may refer 25 people who sign up for the system. Next, those 25 people may each refer another 25 people who sign up with the system, totaling 625 people. If each of those people then refers another 25 people then the total number of potential passive revenue sources could be 16, 275 for the initial user.

FIG. 4 illustrates a payout schedule diagram 400, according to some embodiments. As shown in the example embodiment, an advertisement's initial price per view that is paid by the advertiser can be determinative of how much an individual user might earn by viewing the advertisement and how much the individual might passively earn by their referral(s) viewing the same advertisement (or one valued the same). For example, if a particular advertisement price was $1.00, then an initial user may earn 25% of that price by selecting and viewing the advertisement. A first level referral of the user who views the same advertisement may earn the initial user an additional 8% of passive revenue. A second level referral may earn the initial user an additional 8%, while a third level referral may earn the initial user an additional 5%. In various embodiments, payouts may be higher than on other platforms because the advertiser is virtually guaranteed to have their advertisement shown to someone who is interested in the subject matter by nature of the fact that the user has self-selected the category or code of the advertisement that is displayed to them. Thus, the advertiser is not blindly advertising to hoards of people who have no interest in their products, whatsoever. Instead, they are advertising to self-selected interested users who are actively engaged in watching the advertisements.

Any environment where digital advertisements are combined with a multi-level referral compensation system, where compensation is based on (a) placement of an advertisement, and/or (b) a user viewing or clicking an advertisement may benefit from the embodiments described herein. These can include currently existing systems and methods and those later developed. With the growing desire for privacy in the public, the teachings and features described herein are projected to become increasingly popular. Users are limited in the number of subsections that they can select in a particular code to prevent a user from selecting “all” codes. This can encourage users to select subsections that they are actually interested in and to allow the system to properly function for the purposes of targeting actual potential customers for advertisers.

Various embodiments of the systems and methods described herein are contemplated and may be implemented over any environment where digital ads are delivered—including, the Internet, mobile applications, alternative reality (AR), virtual reality (VR), metaverse, artificial reality, digital wallets, online exchanges, or others. Furthermore, payments to users and entities who are viewing advertisements and/or who are earning passive income can be digital or real currencies that may be platform specific or fungible across multiple platforms and/or in the real world.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

FIG. 5 illustrates a flowchart of a system and method for delivering anonymized targeted advertisements while providing multi-level compensation to users. The system allows for targeted advertisements to be delivered to specific users via various means including referals while generating income based on the advertisements viewed. A server is communicatively coupled to a network and including a processor that performs various steps. A first user profile is created and stored for a user in non-transitory, computer readable memory when a first user accesses the system using a first user device via the network and selects a sign-up feature. At least one category is provided and associated with at least one advertisement, that the first user can select, to the first user device and which is stored in association with the first user profile when selected by the first user via a first user interface of the first user device. At least one advertisement is sent to the first user's device that is associated with one or more aspects of the first user's demographic profile or at least one category selected by the first user. Once the first user device indicates that the user has viewed the at least one advertisement, crediting the first user account with a credit that can be used toward a payout to the first user.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

1. A computer network-implemented digital advertising platform system that protects the privacy of users, comprising:
a server communicatively coupled to a network and including a processor that performs the steps of:
creating and storing a first user profile comprising a code for a user in non-transitory computer readable memory when a first user accesses the system using a first user device via the network and selects a sign-up feature;
providing at least one category associated with at least one advertisement based on the code, that the first user can select, to the first user device and which is stored in association with the first user profile when selected by the first user via a first user interface of the first user device;
sending at least one advertisement to the first user's device that is associated with one or more aspects of the first user's demographic profile or at least one category selected by the first user; and
once the first user device indicates that the user has viewed the at least one advertisement, crediting the first user account with a credit that can be used toward a payout to the first user.

2. The system of claim 1, further comprising:
a referral system, wherein the first user earns passive income based on engagement of a second referral user when the second referral user views an advertisement via the system.

3. The system of claim 2, wherein the referral system further comprises:
the first user earns passive income based on engagement of a third referral user, where the third referral user views an advertisement via the system and where the third referral user is referred to the system by the second referral user.

4. The system of claim 2, wherein the referral system further comprises referral tracking wherein the first user can monitor advertisement viewing by downline referral users.

5. The system of claim 2, wherein the referral system further includes referral codes.

6. The system of claim 1, wherein the at least one category selected by the first user is associated with a user interest.

7. The system of claim 1, wherein the at least one category selected by the first user is associated with an advertising category including advertisements that the first user is interested in viewing.

8. The system of claim 1, wherein the sending at least one advertisement to the first user's device that is associated with one or more aspects of the first user's demographic profile is influenced by other users with similar demographic profiles.

9. The system of claim 1, wherein an advertiser can view anonymized data regarding users who view the advertiser's advertisement.

10. The system of claim 1, wherein the first user refers an advertiser and earns credits based on the amount of money that the advertiser spends advertising via the system.

11. An anonymized online digital advertising platform, comprising instructions stored in computer memory that, when executed by a processor, cause the processor to:
present digital advertisements to existing users based on categories associated with the digital advertisements and codes associated with user profiles;
store new user referrals by existing users in association with the existing users;
track the digital advertisements viewed by existing users and their new user referrals; and
compensate existing users based on their viewed digital advertisements and digital advertisements viewed by their downline user referrals.

12. The platform of claim 11, wherein a first existing user earns passive income based on engagement of a second referral user when the second referral user views an advertisement via the platform.

13. The platform of claim 12, wherein:
the first existing user earns passive income based on engagement of a third referral user, where the third referral user views an advertisement via the platform and where the third referral user is referred to the system by the second referral user.

14. The platform of claim 12, wherein the platform further comprises referral tracking wherein the first user can monitor advertisement viewing by downline referral users.

15. The platform of claim 12, wherein the platform further includes referral codes.

16. The platform of claim 11, wherein the at least one category selected by the first user is associated with a user interest.

17. The platform of claim 11, wherein the categories are selected by the existing users and are associated with an advertising category including advertisements that the existing users are interested in viewing.

18. The platform of claim 11, further comprising instructions stored in computer memory that, when executed by the processor, cause the processor to:
present advertisements based on at least one aspect of the existing users' demographic profiles, which are influenced by other existing users with similar demographic profiles.

19. The platform of claim 11, wherein an advertiser can view anonymized data regarding existing users who viewed an advertiser's advertisement.

20. The platform of claim 11, wherein existing users can refer an advertiser and earn credits based on the amount of money that the advertiser spends advertising via the system.
